(19) United States
(12) Patent Application Publication
(10) Pub. No.: US 2002/0140636 A1
(43) Pub. Date: Oct. 3, 2002

(54) Matrix display device and method

(76) Inventors: Antonius Hendricus Maria Holtslag, Eindhoven (NL); Roel Van Woudenberg, Eindhoven (NL); Willibrordus Adrianus Johannes Antonius Van Der Poel, Eindhoven (NL); Herman Schreuders, Eindhoven (NL); Sander Derksen, Eindhoven (NL)

Correspondence Address: U.S. Philips Corporation, 580 White Plains Road, Tarrytown, NY, 10591, US

(21) Appl. No.: 10/023,196

(22) Filed: Dec. 18, 2001

(30) Foreign Application Priority Data
Dec. 20, 2000 (EP) 00204654.8

(51) Int. Cl. G09G 3/20

(52) U.S. Cl. 345/55

(57) ABSTRACT

The present invention provides for a matrix display device (10) and related method of controlling light output from such a device employing sub-field addressing (14) and comprising determining the display load of the device (10), and further including the steps of dynamically varying the number of sub-fields available for display of an image responsive to said display load being determined (16) to be below a threshold value and advantageously employing partial line doubling and/or dithering (22,24) for at least the least significant bits of the display signal.

The present invention relates to a matrix display device and a related method of controlling light output from such a device employing sub-field addressing and comprising determining the display load of the device.

Such a device and method is known, for example, from WO-A-99/30309 but is disadvantageous in that the level of light production remains restricted and the light output and power specification, particularly at low display loads, are far from ideal. The number of grey levels available at low display loads is also disadvantageously limited.

The present invention seeks to provide for a matrix display device and related method having advantages over known such devices and methods. In particular, the present invention seeks to provide for a matrix display device and related method allowing for an increased light output at low display loads and advantageously without exceeding the maximum power load of the sustain power supply.

According to one aspect of the present invention there is provided a matrix display device of the type defined above, characterized by determining means for determining the display load of the device, and control means for dynamically varying the number of sub-fields available for display of an image responsive to said determined display load being below a threshold value.

According to another aspect of the present invention there is provided a method of the type defined above and characterized by the steps of dynamically varying the number of sub-fields available for display of an image responsive to said display load being determined to be below a threshold value.

The invention is particularly advantageous in that, through the dynamic monitoring of the display load, the number of sub-fields can be reduced when the display load falls below a threshold value. This then serves to reduce the total scanning periods (also known as address periods) within one field and so allows for a corresponding increase in the time available for the sustain periods so as to provide for an enhanced bright display even at low display loads. A further particular advantage is that the number of sustain pulses can be increased in this manner to a number suitable for maintaining the power drawn by the display from the sustained power supply to near its maximum value.

The features of claims 2 and 3 relate to various aspects of the invention which can proved advantageous in retaining a required number of grey levels whilst still allowing for the reduction in the number of sub-fields in accordance with the present invention.

The features defined in claim 4 relate to a particularly efficient and effective means for dynamically determining the display load and the features of claims 5 and 6 define particularly advantageous features of the dynamic behavior and relating to the determination of the number of sub-fields selected.

The features defined in claim 7 provide hysteresis to reduce artefacts like flicker, when the display load various around a value at which the number of subfields is changed.

The features defined in claim 9, 10 and 11 provide an improvement of the voltages margins wherein the device can be operated correctly.

These and other aspects of the invention are apparent from and will be elucidated with reference to the embodiments described hereinafter.

In the drawings:

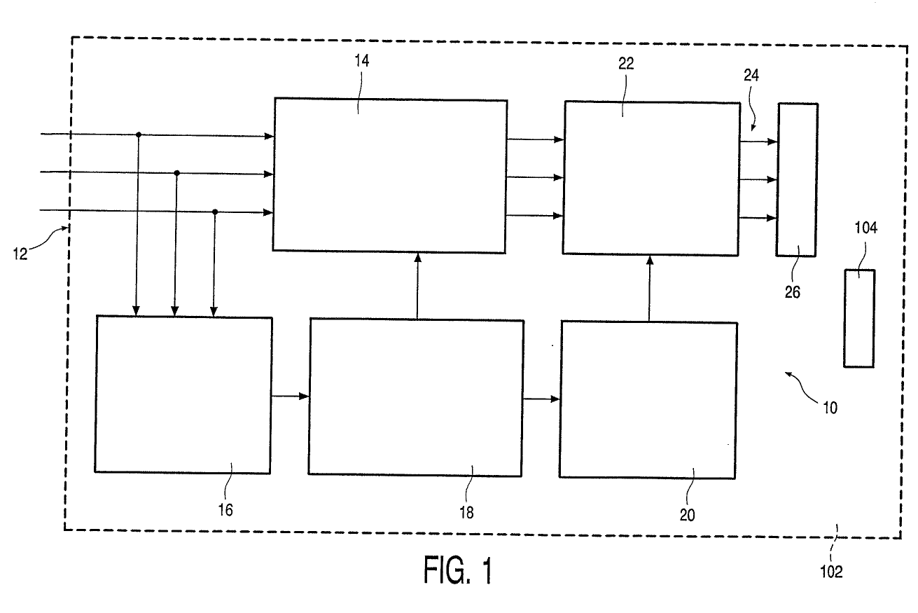

FIG. 1 shows a block diagram of a display apparatus comprising a matrix display device in accordance with the invention.

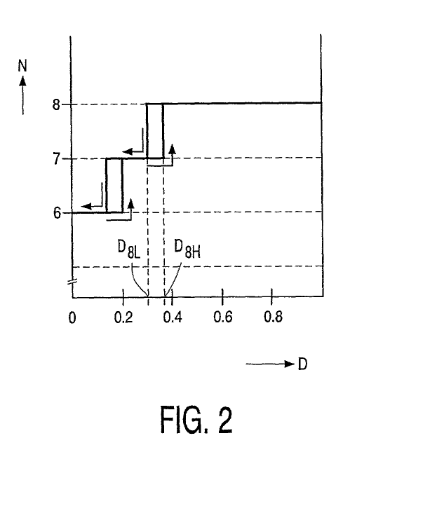

FIG. 2 shows a graph for elucidating the hysteresis introduced when changing the number of subfields in the display apparatus shown in FIG. 1.

The drawing in FIG. 1 comprises a schematic block diagram illustrating one embodiment of a display apparatus comprising a display device including a plurality of light emitting elements as found within a matrix display and also including associated drive means for delivering color video signals to the light emitting elements.

The drawing in FIG. 2 comprises a graph explaining the hysteresis introduced when changing the number of subfields.

In further detail, FIG. 1 illustrates a matrix display device 10 arranged for receiving color video signals 12 which are delivered to both a sub-field convertor 14 and a display load determination means 16. The display load determination means 16 monitors and analyses the incoming video signals 12 so as to establish the display load that will arise when displaying the image on the screen of the matrix display device 10. The sub-field convertor 14 serves to impose a sub-field timing scheme on the incoming video signals 12 so as to divide the signals into a plurality of sub-fields for achieving the required luminance in the displayed image.

The display load determination means 16 delivers a signal to control means 18 which, in turn, is arranged to deliver a control signal to the sub-field convertor 14 and to a partial line doubling/dithering application means 20. The control means 18 is arranged to deliver the said control signals to the sub-fields convertor 14 and the partial line doubling/dithering application means 20 on the basis of the display load determined by the display load determination means 16. Should the display load be determined to be below a threshold value, then the control means 18 is arranged to deliver its control signals to the sub-field convertor 14 and the partial line doubling/dithering application means 20. Upon receipt of the said control signal, the sub-field convertor 14 is controlled to reproduce the incoming video signal 12 with a reduced number of sub-fields; whereas the partial line doubling/dithering application means 20 is arranged to apply partial line doubling and/or dithering by means of a matrix display drive means 22 which receives the reduced sub-field signals from the sub-field convertor 14. The partial line doubled and/or dithered signals 24 output from the drive means 22 are then delivered to the light emitting elements of a matrix display 26.

Furthermore, FIG. 1 illustrates a display apparatus 102 comprising the display device 10 and a power supply 104.

The operation of the present invention is now discussed further below.

Within the present inventive concept, a method is proposed to increase the light output at low display loads, without exceeding the maximum power load of the sustain power supply.

This is illustrated further below wherein the maximum display load, which is proportional to the number of cells of the matrix display turned on multiplied by their on time, is given by D0 and occurs at S0 sustain pulses and at a luminance of L0. If the actual display load D is greater than D0, the maximum number of sub-fields N0 is used and no partial line doubling or dithering (as discussed later) is applied. If required, the maximum load D0 is limited by decreasing the number of sustain pulses S such that the luminance L is adapted according to the formula S/L=S0/L0 and the power drawn from the sustain power is limited to a maximum value. However, if the actual display load D is less than D0, the address time is reduced in accordance with the present invention by reducing the number of sub-fields used such that the number of sustain pulses can be increased, preferably to an amount suitable for keeping the power drawn from the sustain power supply near to its maximum value.

Using partial line doubling for the least significant bits or by using dithering, or combination of both lowers the number of sub-fields while advantageously retaining the number of grey levels available.

For other matrix displays, multiple frame surface addressing can be used to decrease the addressing time. That is, a method of displaying successive image frames on a subfield driven matrix display device comprising display lines being addressed in sets of adjacent lines can be employed wherein the image frames or fields having original luminance value data are coded in subfields comprising a group of most significant subfields and a group of least significant subfields. A common luminance value is supplied to lines of a set of the sets of lines and the addressing in sets of adjacent lines is performed differently for successive frames or fields, for different regions of the display device and/or for different subfields.

Thus, grouping adjacent lines in sets of lines is performed differently for each successive frame and for different regions of the display device, e.g. lines may be grouped by three in the upper half of the display, and by two in the lower one, in odd frames, and in reverse in even frames serves to reduce the address period or addressing time without impairing image definition and without creating motion artefacts. This can leave more time for sustain periods. A common luminance value for one or more subfields is thereby addressed simultaneously to all lines of a set of lines. By grouping the lines differently in successive frames and/or different areas of the display, an advantageous further reduction in the address period is obtained, without loss of resolution.

The following example further illustrates this aspect of the invention. First, it is assumed that the maximum number of sub-fields Nₘₐₓ=8 sub-fields on a VGA display, such that 256 grey levels can be obtained.

The total time T needed to address a Plasma Display Panel (PDP) can be represented as:

T=T_{E}+T_{A}+T_{S}=E×(0.1 ms)+N×(1.54 ms)+S×(2.7 us)

where T_{E} denotes the erase time, T_{A} denotes the address time, and T_{S} denotes the sustain time.

With, for example PDPs, the power consumption increases in proportion to the display load D and the display load D is a relative number between 0 and 1, which is proportional to the number of cells turned on, multiplied by the on-time. Thus, for a completely white image the display load is 1, while for a completely dark image the value is 0. In this example it is assumed that only a sustain power P0=150W is available in the PDP, and is sufficient to create a luminance L0=235 cd/m2 at a display load of D0=0.25, using S0=1000 sustain pulses.

The two situations noted above are again considered, i.e. display load higher than D0, and a display load lower than D0. At a higher display load the number of sustain pulses is reduced, such that S/L=S0/L0. This means that the maximum luminance reduces, according to L×(D+C)=L0×(D0+C) where C is a constant which is commonly in the region of 0.07 which relates to offset in the display load. It should of course be appreciated that the 8 sub-fields with single line addressing are used as usual. At lower display loads dithering and/or partial line doubling is employed in order to assist with a reduction in the address time needed. This will therefore allow for an increase in the sustain time available and the number of sustain pulses applied, which in turn allows for a high luminance at low display loads. Importantly the relationship for L×(D+C)=L0×(D0+C) remains true.

The required erase time T_{E} equals the number of sub-fields E which will be erased multiplied by the time needed to erase one sub-field, which is about 0.1 ms/sub-field. In current address methods the value of E=1, but for the sake of clarity it can be taken to be equal to the number of sub-fields i.e. E=Nₘₐₓ.

With N being the number of subfields used and t_{A} the time needed for addressing a single subfield, the address time T_{A} required=N×t_{A} and is noted in Table 1 below assuming partial line doubling is applied. In Table 1, the value of N ranges from 5 to 8 and for addressing a single field with single line addressing a time of t_{A}=480 rows×3.2 us/row=1.54 ms is needed. Table 2 illustrates the total address time calculated.

The sustain time T_{S} needed, equals the number of sustain pulses S applied multiplied by the time needed for a single pulse event, i.e. about 2.7 us. In Table 2, the sustain time is calculated and illustrated for a 50 Hz (20 ms field period) and 60 Hz PDP operation (16.6 ms field period).

It should be appreciated that only results for integer numbers are listed.

TABLE 1
The number of MSBs and LSBs needed for the address time reductions.

| | MSBs | LSBs | Total address |
|---|---|---|---|
| | Single line | Double line | time |
| N_{ub-fields} | Addressing | Addressing | In units of t_{A} |
| 8 | 2 | 6 | 2 + 6x½= 5.0 |
| 8 | 3 | 5 | 3 + 5x½ = 5.5 |
| 8 | 4 | 4 | 4 + 4x½ = 6.0 |
| 8 | 5 | 3 | 5 + 3x½ = 6.5 |
| 8 | 6 | 2 | 6 + 2x½ = 7.0 |
| 8 | 7 | 1 | 7 + 1x½ = 7.5 |
| 8 | 8 | 0 | 8 |

TABLE 2
The number of sustain pulses produced.

| Number N | | | Tₛᵤₛₜₐᵢₙ | | Tₛᵤₛₜₐᵢₙ | |
|---|---|---|---|---|---|---|
| of time t_{A} | Tₑᵣₐₛₑ | T_{address} | @ 50 | | @ 60 | |
| needed | (ms) | (ms) | Hz (ms) | Nₚᵤₗₛₑₛ | Hz (ms) | Nₚᵤₗₛₑₛ |
| 5 | 0.8 | 7.70 | 11.5 | 4259 | 8.1 | 3000 |
| 6 | 0.8 | 9.24 | 9.96 | 3689 | 6.6 | 2430 |
| 7 | 0.8 | 10.8 | 8.40 | 3111 | 5.0 | 1850 |
| 8 | 0.8 | 12.32 | 6.88 | 2548 | 3.5 | 1288 |

At 1000 sustain pulses, a luminance of about 235 cd/m2 or more can be produced in current plasma display panels. At 4259 pulses luminance of 1000 cd/m² can therefore be expected at 50 Hz, At 3000 pulses, a value of 700 cd/m² is realistic at 60 Hz.

In this example, in order to increase the brightness of a PDP up to 700 cd/m2 at 60 Hz operation (or even 1000 cd/m2 at 50 Hz), the invention advantageously employs partial line doubling and/or dithering during the creation of the high luminance, such that the power consumption for light generation is always fixed to a constant value, for example 150W, and such that 256 grey levels can always be obtained. At low display load the 6 LSBs are partial line-doubled and/or dithering is applied, while at a high display load no lines are doubled and/or no dithered applied.

To further the example, if 6 sub-fields are used, dithering can be employed to give near 8 bit equivalent picture. In such a case the method will be limited to 6 sub-fields, avoiding a lesser image quality.

As a further illustration, the 3 MBSs with single line doubling and the 3LSBs with line-doubling can be advantageously dithered in order to obtain an 8 bit equivalent picture.

The above illustrates that each maximum light output L can be realized as D changes and the display load can be continuously recorded by a microprocessor.

As mentioned above, if D is greater than D0, and the number of sub-fields is taken as 8, the number of sustain pulses is calculated according to S/L=S0/L0 and the result will be a number S less that S0, and sufficient sustain time will be available. If D is less than D0, the number of sustain pulses is also calculated using S/L=S0/L0, but that can only be achieved if partial line doubling and, for example, less sub-fields are used. The effective number N of address periods can be calculated with:

N=[T−(T_{E}+T_{S})]/t_{A.}

where T_{S}=S×2.7 us and T_{E} is a fixed number, while t_{A} will be about 1.54 ms. If N becomes lower than 5, the number will be taken as 5 and the corresponding number of sustain pulses will be determined based on the above relationship. If a number between 5 and 8 is obtained, the numbers illustrated in Table 2 are used and these can be stored in a look up table for instance. The image will then be displayed using those numbers.

If the display load changes, the numbers for S and N are changed accordingly, or the settings can be delayed by applying a filter. The reaction time depends on the overload allowed at the power supply.

A reduction of the number of sustain pulses at a higher display load results in an idle time wherein the light emitting elements are not receiving any drive. If this idle time is present in between the sustain pulses of a subfield and an erase pulse following these sustain pulses, then due to a loss of priming particles depending on the idle time, the discharge during erase can fluctuate, resulting in a reduction of the voltage margins wherein the light emitting elements can be operated correctly. By positioning the idle time behind the erase pulses the problem can be reduced, however, in that case the priming will still be influenced by the idle time, resulting again in some reduction of the voltage margins.

The best solution is to position the idle time between a first portion and a second portion of the sustain pulses in a subfield, thereby avoiding an idle time between the last sustain pulse and the next phases starting with erasing.

In case duplicated subfields are used, the idle time should be positioned in both subfields having the same weight.

The idle time can be positioned in the last subfield of a frame, but also in any other subfield or can be split over a number of subfields.

By introducing hysteresis when changing the number of subfields artefacts such as flicker can be reduced. Such a flicker can occur if the display load D of subsequent displayed images is varying around a value at which the number of subfields N is changed. FIG. 2 illustrates the hysteresis: when a display load D of an image is above D_{8H} the number of subfields N applied is 8. When a next image has a display load lower than D_{8L} the number of subfields N will be reduced to 7. If a next image has a display load D higher than D_{8H} the number of subfields N will be increased again to 8.

The provision for the hysteresis can be incorporated into the control means 18. From above can be concluded that after a change of the number of subfields N a next image has to have a change of display load of at least (D_{8H}-D_{8L}) before the number of subfields N is changed again. A typical value for (D_{8H}-D_{8L}) is about 0.02.

From the above it will be appreciated that the invention advantageously involves a single scan with the maximum amount of sub-fields, that is 8 currently for VGA displays. This will limit the brightness to a low value, but sufficient for high display loads. But as soon as the load reduces, partial line doubling and/or dithering is applied which will still give an 8 sub-field equivalent display but with less addressing time however. Therefore the sustain time can be increased. It is then always possible to realize 256 grey levels, while motion artefacts can be removed for instance with motion compensation.

It will be appreciated that the invention is applicable to a wide variety of matrix display device such as Plasma Display Panels and Digital Mirror Devices.

The invention therefore advantageously allows for improved light output at low values of the display load. As mentioned the invention is particularly suited to PDPs in addition to other matrix displays.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A matrix display device (10) comprising a plurality of light emitting elements (26), drive means (14, 22) arranged for sub-field addressing of the light emitting elements (26) and characterized by determining means (16) for determining a display load of the device, and control means (18) for dynamically varying a number of sub-fields available for display of an image responsive to said determined display load being below a threshold value.

2. A device as claimed in claim 1 wherein
the drive means (14, 22) comprises a subfield converter (14) and a matrix display drive means (22), coupled to the subfield converter (14);
both the subfield converter (14) and the determining means (16) are receiving an incoming video signal (12);
the determining means (16) comprises means for providing information about the display load to the control means (18);
the control means (18) is coupled to the subfield converter (14) for dynamically varying the number of subfields available to display the image; and
the matrix display drive means (22) are coupled to the light emitting elements (26).

3. A device as claimed in claim 2 comprising means (20) for applying partial line doubling and being coupled to the control means (18) to receive information related to the display load and coupled to the matrix display drive means (22), to apply partial line doubling responsive to said display load being determined to be below a threshold value.

4. A device as claimed in claim 2 comprising means (20) for applying dithering and being coupled to the control means (18) to receive information related to the display load and coupled to the matrix display drive means (22) for applying dithering, responsive to said display load being determined to be below a threshold value.

5. A device as claimed in claim 1 and including means (20) for applying partial line doubling responsive to the said display load being determined to be below a threshold value.

6. A device as claimed in claim 1, and including means (20) for applying dithering, responsive to the said display load being determined to be below a threshold value.

7. A device as claimed in claim 1, and determining means (16) comprising processor means for continuously monitoring the display load.

8. A device as claimed in claim 1, wherein the control means (18) is arranged to operate in accordance with the relationship S/L=S0×L0 wherein S0 and L0 are the maximum number of sustain pulses and the maximum luminance at which the maximum display load occurs and S and L are the number of sustain pulses and luminance when the display load is determined to be under the threshold value.

9. A device as claimed in claim 8, wherein an idle time resulting from the sustain pulses having a number lower than the maximum number of sustain pulses is present after erase pulses positioned after the sustain pulses.

10. A device as claimed in claim 8, wherein an idle time resulting from the sustain pulses having a number lower than the maximum number of sustain pulses is present in between a first and a second portion of the sustain pulses of a subfield.

11. A device as claimed in claim 10, wherein a duplicated subfield is present and the idle time is split between subfields having a same weight.

12. A device as claimed in claim 1, wherein the control means (18) is arranged to operate in accordance with the relationship L×(D+C)=L0 ×(D0+C) where L and L0 represent luminance values at the time of display load being below the threshold value and at maximum display load, C is a constant in the order of 0.07 and D and D0 represent display load values at the time of display load being below the threshold value and at maximum display load.

13. A device as claimed in claim 1 wherein the control means (18) is arranged to introduce hysteresis by increasing the number of subfields at a higher value of the display load compared to the display load at which the number of subfields is reduced to the number of subfields before increasing the number of subfields.

14. A method of controlling light output from a matrix display device employing sub-field addressing and comprising determining the display load of the device, and characterized by the steps dynamically varying the number of sub-fields available for display of an image responsive to said display load being determined to below a threshold value.

15. A display apparatus (102) arranged for receiving a video signal (12) and for processing the signal so as to display an image determined by the signal, the image determining a display load within the apparatus, and the apparatus having means (104) for receiving a power supply having regard to the display load, and further having a matrix display device as claimed in claim 1.
